(19) United States
(12) Patent Application Publication
(10) Pub. No.: US 2005/0185784 A1
(43) Pub. Date: Aug. 25, 2005

(54) Method and electronic device for selective telephone call screening

(76) Inventors: Samuel Chiu, Windsor (CA); Edward Samson Chiu, Windsor (CA); Albert Herman Chiu, Windsor (CA)

Correspondence Address: Samuel Chiu, 581 Campbell Avenue, Windsor, ON, N9B 2H5, CA

(21) Appl. No.: 10/781,837

(22) Filed: Feb. 20, 2004

(51) Int. Cl. H04M 3/42

(52) U.S. Cl. 379/210.02; 379/207.15

(57) ABSTRACT

The invention relates to a method and electronic device for user specific, selective, telephone call screening. The method affords one a multitude of choices and options relative to telephone call screening employing calling number identification values and user screening rules.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The present invention relates generally to telephone call blocking services, and more specifically to a selective telephone call screening method implemented at the premises of the call recipient.

1. Description of Related Art

Several US patents disclose methods for identifying and blocking calls by subscribers of public telephone services, e.g., Solomon et al, U.S. Pat. No. 5,596,627; Holiday, II, U.S. Pat. No. 6,385,310 B1; Leung et al, U.S. Pat. No. 6,005,870; Bell et al, U.S. Pat. No. 6,549,619 B1; and Pelletier et al, in U.S. Pat. No. 6,496,569 B2.

These methods include communication protocols, codes and other software programs operating through central and local telephone company offices, and ultimately allow an end user the ability to selectively screen incoming calls.

Numerous attempts have been made as well to offer telephone service subscribers various programming and identification means to block unwanted incoming calls via convenience features, e.g., Latter et al, in U.S. Pat. No. 6,574,319 B2; or Knuth et al, in U.S. Pat. No. 5,781,613.

Additionally, still other methods and devices aimed at selective caller identification services, such as, switching methods, station software, and access codes are discussed in U.S. Pat. Nos. 6,553,110 B1; 6,584,178 B2; and 6,332,021 B2; invented by Peng; Crockett et al; and Latter et al respectively.

2. Background Information

As the general population continues to commit more hours to working, they value time spent at home and desire it to be free from unwanted distractions. The telephone serves as an invaluable form of communication, but introduces many nuisances into the home. Interruptions may be caused by unwanted calls from telemarketers or wrong numbers, or from known callers calling at inopportune times. In some cases, callers may continue to attempt to contact the recipient against the recipient's noted wishes. These calls may represent more than a nuisance and a form of harassment to the recipient. People always have the option of muting the telephone ringer, but this action eliminates the audible signaling of all calls including the ones they may wish to receive.

Recognizing these frustrations, telephone service providers have leveraged the functionality of caller identification (ID) technology to offer various call blocking services. The telephone company has access to the originating Calling Number Identification (CNID). This caller information is the basis for caller identification services, and it allows the telephone company to provide call blocking services before calls reach the recipient.

In cases with a history of harassing telephone calls from the same caller a recipient may request the telephone company to block any further contact from said caller. In less drastic cases the telephone company can offer services blocking calls originating from 900 calling codes, toll-free calling codes, and numbers with unknown caller ID information. A caller initiates a call and the telephone company upon receiving the caller ID checks if the recipient has subscribed to any call blocking services. If the caller's ID matches a category the recipient subscribes to a blocking service for the call is not connected and the caller is informed of this block by a message from the telephone company.

As these services require the intervention of the telephone company, they are limited in scope and application to what the service provider decides to offer. Not all telephone companies will offer these services. If they are offered, a telephone service subscriber must contact the telephone company to initiate the service and to make any subsequent changes. Other telephone company services include blocking callers from a list specified by the recipient or only allowing callers from a recipient specified list. Again, these services have the disadvantages of limited availability, the onus on the telephone user to contact the telephone company whenever changes are made to the lists, and typically, a limitation on the size of the lists (could be as few as 3 telephone numbers) imposed by the telephone company.

Aside from a small list of specific numbers, telephone line subscribers are only offered blocking services on large subsets of special callers: toll-free callers or callers with unknown caller ID for example. Existing services do not afford the subscriber the ability to block calls according to area codes or exchanges. Numbers are blocked on an all or nothing basis with no degree of masking.

Furthermore, the call blocking service offered by telephone companies is time-inflexible, costly and cumbersome: 1) Once activated they are always active until the subscriber changes the subscription. 2) There is a monthly service charge. 3) It does not offer different call screening rules depending on the time of day, and 4) It does not offer individual screening options to a each phone number being screened.

The User may trade off the possibility of blocking wanted calls for stricter screening during night hours while preferring a more lenient system during the day. Although it is conceivable for the telephone company to offer these expanded functionalities, the subscriber has no control over the situation. The decision to expand call block functionality or to offer the services at all rests solely with the telephone company. Prior art has not afforded the telephone subscriber the ability to effectively screen incoming telephone calls in a flexible and highly controllable manner without intervention from the telephone company.

### BRIEF SUMMARY OF THE INVENTION

It is the object of the present invention to provide a means for a telephone line subscriber or telephone call recipient (hereafter referred to as ‘User’) to selectively screen incoming telephone calls that overcomes the limitations of the aforementioned prior art.

It is also an object of the present invention to provide means for a telephone line and caller ID service subscriber to screen incoming telephone calls without further intervention by the telephone company.

It is further an object of the present invention to allow means of screening by blocking specifically stored telephone numbers, only allowing specifically stored numbers or any combination thereof by validating the CNID with a database stored in the electronic call screener of claim 5 (hereinafter referred to as the “Call Screening Device” or “CSD”) installed at the recipient's premises. A CSD can be a stand-alone unit or incorporated into another device to serve the purposes of this invention.

It is further an object of the present invention to allow means of validating CNID by wildcard searches whereby a call may be screened based on area code, exchange number, or other user selected format.

It is still further an object of the present invention to allow means of setting the aforementioned call screening objectives based on a time schedule.

The present invention includes the steps conducted at the call recipient's premises of determining the CNID value of an incoming call and processing the call according to the User defined screening rules. A decision would be made whether the call should be allowed or blocked. The call recipient must subscribe to a caller ID service provided by the local telephone company.

When an incoming call is placed, the telephone company transmits the calling party's CNID to the call recipient. This CNID value is checked against a database of CNID values and call screening rules stored at the recipient's CSD. Rules determine if a call originating from a particular CNID value should be blocked or allowed to ring.

A CNID value that is previously stored in the database has associated screening rules assigned by the User. The User may enter the CNID values and rules into the database through an interface on the CSD. CNID values of previous callers stored in the device buffer may also be added to the database of the CSD with the desired screening rules.

Further user specification allows the recipient to assign time-dependent variations of the screening rules. In certain situations the recipient may not receive caller's valid CNID due to: a) the caller may have elected to block transmission of his outgoing telephone number; b) inter-carrier handoff of a long distance telephone call may result in loss of the original CNID value; and, c) the CNID data may be corrupted during transmission of the call. Accordingly, the CNID value passed is not a telephone number but a standard message relaying the cause of a non-numeric CNID.

The CSD stores the User's chosen screening actions when these situations are encountered: non-numeric CNID values also have associated screening rules that decide if the call should be blocked or allowed to ring the recipient. Any numeric CNID value that is not present in the database is considered as another calling situation with user assigned screening rules. An incoming call cross-referenced and flagged as allowed to pass will continue ringing the recipient telephone line.

On an incoming call that is cross-referenced and flagged for blocking, the recipient may pre-set the option of allowing the calling party to provide authentication before the call being rejected. If the authentication option is enabled, the calling party will be prompted to enter a numeric authentication code that is stored in the recipient's database. Proper authentication will allow the call to continue ringing. Incorrect authentication, or in the event the authentication option is disabled, an incoming call flagged for blocking will be disconnected to prevent ringing of the recipient's telephone line.

A CNID stored in the database of the CSD by the User can be a complete or partial telephone number. The more digits of the telephone number stored the more specific it would be for validate the CNID.

The CSD has the capability of forcing the nighttime screening rules to be used during daytime hours. This is done through a setting on the CSD system level. This enforcement can be temporary or permanent until the User reset it.

### BRIEF DESCRIPTION OF THE DRAWINGS

FIG. 1 is a schematic view of the telephone system with which the method and electronic device for selective telephone call screening according to the present invention can be used.

FIG. 2 is a flow chart of the logical operation of the present invention.

FIG. 3 is a flow chart of the logical operation in detail of FIG. 2 in determining which of the daytime or nighttime screening rules to be used.

FIG. 4 is a flow chart of the logical operation in detail of FIG. 2 in determining a call with valid CNID be blocked or allowed.

### DETAILED DESCRIPTION OF THE INVENTION

The present invention, as referenced in the drawings, utilizes currently implemented telephone service technologies to provide a solution to the aforementioned problems that are not met by current services offered by telephone companies. Currently, the User may add services implemented by the telephone company that are related to or utilize caller ID information of an originating caller:
1) The calling party's CNID, if transmitted, may be displayed on a caller ID device at the User's premises provided caller ID service from the local telephone company has been subscribed.
2) The User receiving harassing telephone calls from an originating caller may request that the telephone company block all calls from that originating number.
3) The User may further subscribe to services offered by the telephone company to block incoming calls from special originating callers: 900-numbers, toll-free numbers, callers blocking transmission of their CNID

The present invention requires subscription to the first service and supersedes the second and third services. The present invention implemented on the call recipient's premises affords the User the ability to selectively block (screen) calls originating from any stored CNID value including the scenarios serviced by aforementioned choices #2 and #3 without further reliance on the telephone company.

A user subscribing to caller ID service from the telephone company receives the originating caller's CNID with every incoming telephone call as in the current caller ID service described in option #1 above. The CNID value received is checked against a recipient-side database for any screening rules the User has defined for that CNID value. CNID values may represent the telephone number of the calling party or special messages if the telephone number is blocked, corrupted, or otherwise unavailable. Each special instance of a non-numeric CNID may also be stored in the database with associated screening rules.

Screening rules define whether an incoming call from a particular CNID should be flagged for blocking or allowed to ring the recipient. A CNID value not present in the database is considered as another situation with associated rules. Screening rules may further be defined in a time-dependent manner, allowing the User to specify different rules for a particular CNID value depending on the system time.

Once an incoming call has been flagged, the device embodying these rules must implement the predefined action. A call flagged as acceptable is allowed to continue ringing the recipient's telephone line unhindered. A call flagged for blocking will be terminated by the device initiating an off-hook command to connect the call followed by an on-hook command to terminate the call.

If the User has activated the authentication procedure, incoming calls flagged for blocking will initiate an intermediate step that allows the calling party to enter an authentication code stored on the recipient-side: proper authentication allows the call to continue ringing; otherwise the device will proceed to terminate the incoming call.

There are various levels of screening rules and securities pass codes as outlined in Tables 1 and 2, but not limiting to. There are two (2) types of system-level pass code, namely, permanent and temporary. The permanent type is the one has been stored in the CSD by the User. The temporary or ‘soft’ type is the one generated and prompted by the CSD at that instance and not stored in the CSD. Temporary type of pass code is used primarily in daytime screening to screen out automated telemarketing or fax but still allow calls made by persons to continue.

TABLE 1
Partial list of Screening Rules (subject to changes)

| CNID | CNID | Day time Rules | | | Night time Rules | | |
|---|---|---|---|---|---|---|---|
| value | Screening | Prompt | Pass code | | Prompt | Pass code | |
| received | Setting | Passcode | Valid | Invalid | Passcode | Valid | Invalid |
| CNID | Always | No | Blocked | Blocked | No | Blocked | Blocked |
| found in | Blocked | | | | | | |
| CSD | Always | No | No | No | No | No | No |
| database | Allowed | | block | block | | block | block |
| | Daytime | Yes | No | Blocked | Yes | No | Blocked |
| | Block | | block | | | block | |
| | Nighttime | No | No | No | No | Blocked | Blocked |
| | Block | | block | block | | | |
| Error or | | Yes, | No | Blocked | Yes | No | Blocked |
| not | | ‘soft’ pass | block | | | block | |
| found in | | code | | | | | |
| CSD | | | | | | | |
| database | | | | | | | |

TABLE 2
Partial list of Pass Code Types (subject to changes)

| Pass code type | | Applies when |
|---|---|---|
| Permanent | Stored in CSD by User. | On Night time or day |
| | Can be modified by | time rules if CNID is |
| | User. | flagged to be Blocked |
| Temporary or soft | Generated & prompted by | On Day time rules & |
| | CSD, not saved. | invalid CNID or not on |
| | | database |
| Authentication | On or Off | It is turned ON |

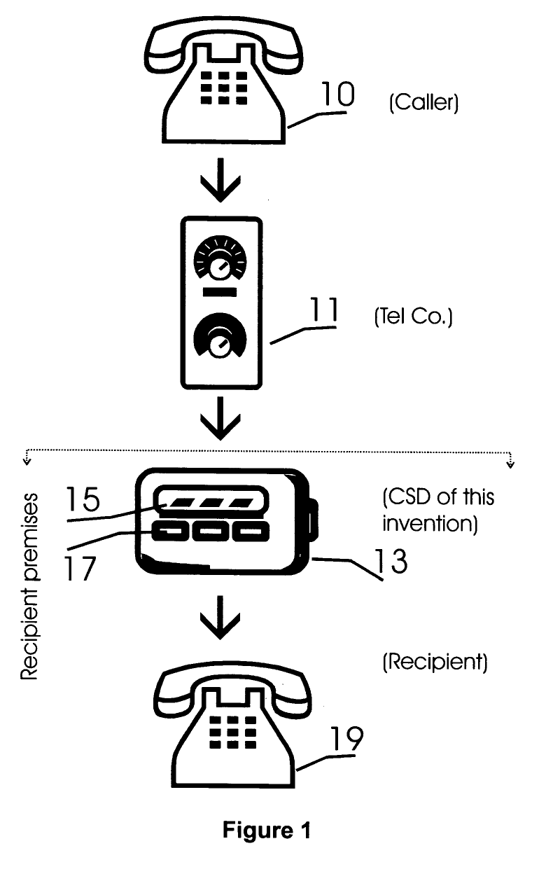

The details of the incoming call screening method will be described in further detail, referring to flow charts of FIGS. 1 to 4.

A user 19 of FIG. 1 subscribing to telephone line service and caller ID service installs the selective telephone CSD 13 on the telephone line on his premises. The User electronically stores a list of telephone numbers and their respective screening rules to the database in the CSD. These numbers and rules will be examined when an incoming call originates from that specific CNID value. The list may be input through a user interface 17 on the CSD a priori or after a new caller's CNID is received. When incoming call is received, the CSD will reference the CNID value with this database to determine how the call will be handled.

A caller 10 determines ahead of time with the telephone company 11 or before the call is placed by entering an override command whether his telephone number will be displayed by a caller ID service. As the telephone company sends the ring signal indicating the attempted placement of a call it sends the CNID value, either the caller's 10 telephone number or a standard message indicating that the telephone number is unavailable (blocked).

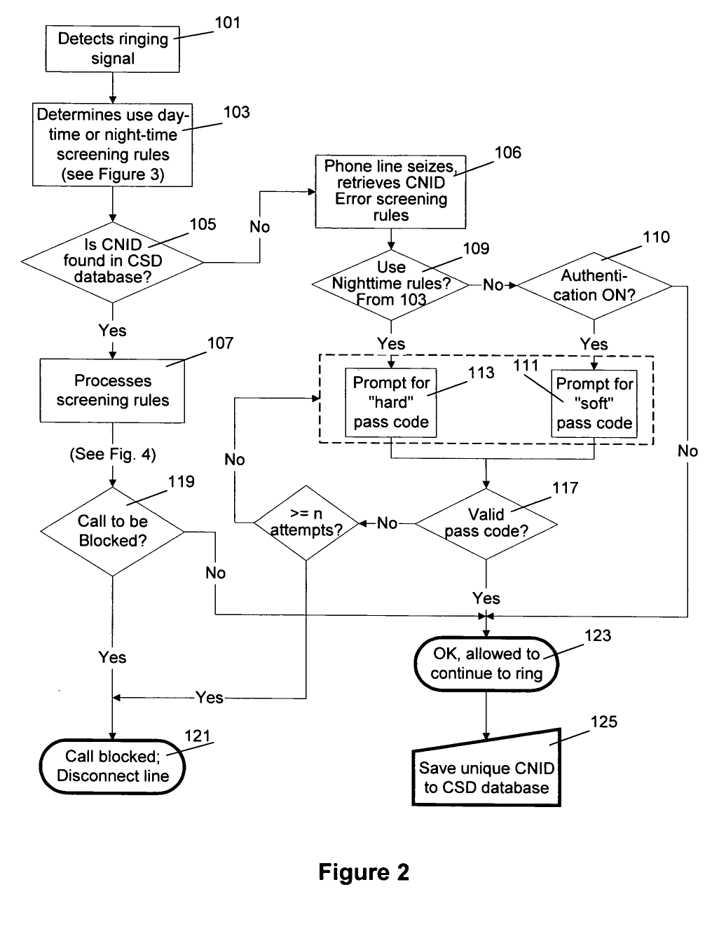

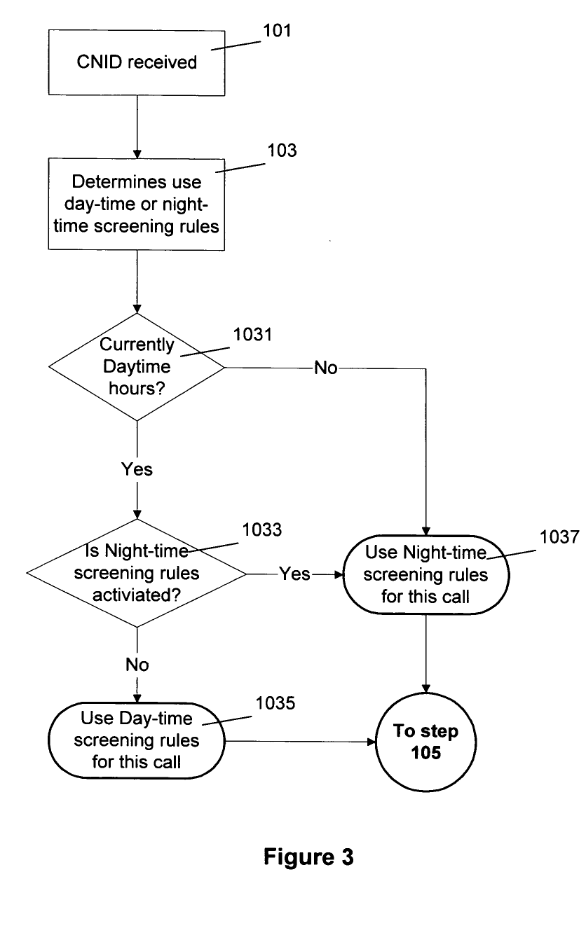

In step 101 of FIG. 2, the CSD detects the ring signal transmitted by the telephone company 11 and receives the CNID of the originating caller. The CSD 13 determines whether daytime or nighttime screening rules should be applied on this call (step 103 of FIG. 2, and details in FIG. 3).

In step 103, it determines whether the daytime or nighttime screening rules is used. Details are in FIG. 3. It will use nighttime rules if the User has triggered the nighttime rules on the CSD, regardless of the current time of the day. This enables the CSD how to handle the call screening rules accordingly. Refer to Tables 1 and 2 for details.

In step 105, it determines if the CNID value is a unique telephone number that exists in the database of the CSD. If the CNID exists in the database, it will proceed to step 107 for further process. If not, it will be considered as a CNID error and proceed to step 106 to retrieve the user-stored rules applying to the particular error message received and further processing.

The CNID received is either a valid CNID or invalid CNID. Invalid CNID includes a) a numeric ID but not found in the database of the CSD, and, b) it consists alphabetic messages.

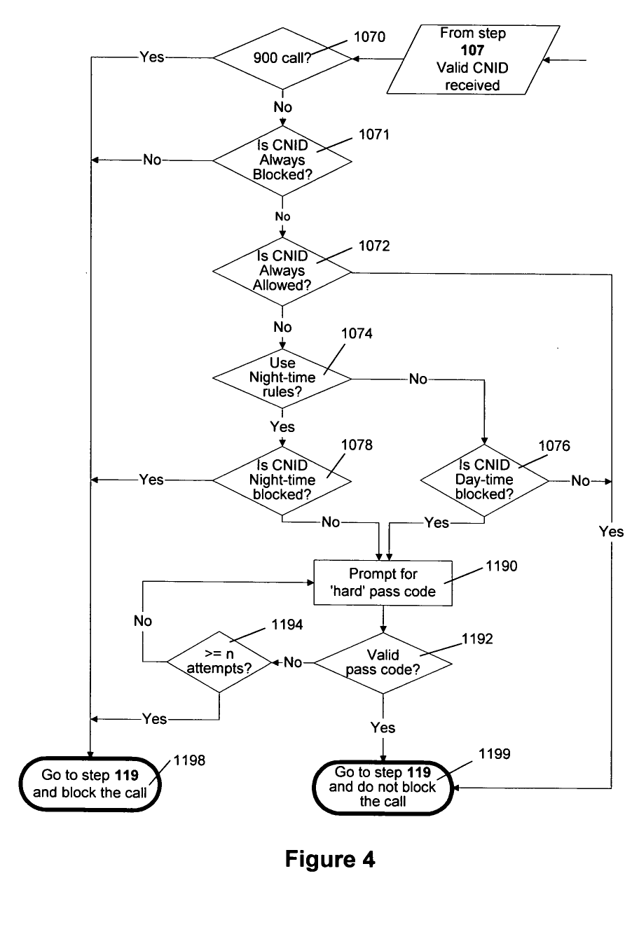

1) Valid CNID—If the CNID value is a unique telephone number, the CSD processes the screening rules as in step 107, detailed in FIG. 4. The status of the call is then fed into step 119, which determines the call either be blocked or allowed to continue to ring.

A database entry for a specific CNID value contains a plurality of screening rules for scenarios differing on time or globally defined user options. Different rules can be stored to the CSD for a CNID value depending on the system time and the user may set the device to only block calls when a rule states the caller should be blocked or only allow calls from callers with rules specifying they should be accepted. The current system time and the global mode selected by the user determine which rules are examined for that caller's CNID (Steps 107 and 106). The call is flagged to indicate if it is allowed to continue or if it should be blocked.

The User can store CNID values with wildcard entries to the database of the CSD to enable convenient masked database searches. The CNID value checked with the database only needs to match the specific CNID digits in a wildcard database entry. This method of partially matching a caller's CNID value with a masked CNID database entry allow the user to define rules for callers originating from entire area codes or exchange prefixes where those digits are the only common digits required for a database match.

If in step 119 it is determined that the caller 10 is placing an acceptable incoming call given the current time and user screening rules the CSD will allow the ring signal to continue and the recipient's telephone 19 will ring (step 123).

If the caller's telephone number is flagged for blocking the CSD will seize the line and connect the call by issuing an off-hook command then disconnect the line (Step 121) by issuing an on-hook command, emulating the action of the User picking up and hanging up the phone receiver.

2) Invalid or CNID Error—If the CNID value is a CNID error message or the CNID not found in the CSD database, the CSD processes the screening rules as in step 106 of FIG. 2. It retrieves the associated screening rules for invalid CNID calls. It has been pre-determined by step 103 that this call is subject to daytime or nighttime screening rules.

The User may specify to let the caller to authenticate a block flagged incoming call and allow the call to continue ringing. If the authentication procedure is enabled the device audibly prompts the caller to enter a pre-specified authentication code (step 111 or 113). For step 113, the caller's response is verified with the code stored in the CSD (hard pass code type). For step 111, the caller's response is verified with the soft pass code generated by the CSD for that particular call. Proper authentication allows the call to continue ringing (step 123) while failed authentication after “n” times of attempts continues with step 121 and disconnects the call as explained before.

In step 109, the CSD decides the type of pass code it expects the caller to respond. The CSD offers the ‘soft’ type of pass code due to the fact that: a) the User does not want every body knows the permanent (hard) pass code stored in the CSD. Changing the permanent code requires the User to inform all the people whom he wants to receive their calls. The soft pass code eliminates this problem; and, b) It eliminates calls from automated dialing systems while still allows calls placed by persons to get through. The soft pass code is generated by the CSD and is different each time.

In step 125, the User has the choice of storing (saving) a unique phone number from the CNID into the CSD database after the call finished. This CNID becomes available for future call checking.

Storing CNIDs—A CNID can be stored either as a complete or partial telephone number. A partial phone number is stored for the wider scope of phone numbers to be screened. The more digits of the telephone number stored the more specific it would be for validate the CNID. For example, 519 123 4567 can be stored as it appears or just as 51, 519, or 51925, etc. When the CSD receives a CNID it searches and retrieves the list from its database either in complete or partial matching. The CSD will only compare the CNID it received up to the last digit of the more specific number it retrieved and ignores the remaining digits of the received CNID. This is an added convenient feature instead of having the User to store all the individual phone numbers for a particular area code, which may deem impossible.

In case where a more specific number is found together with a wider scope one from the database of the CSD, the screening rules of the more specific one will override the broader one. For example, if both 5192522008 and 519 and their associated screening rules are stored in the database of the CSD. When the CSD receives a CNID of 5192522008 it will only apply the screening rules associated with this number, but not the ones of 519. However, if the CNID is from 519 but not 5192522008, then the 519 screening rules will be applied.

All the CNIDs and phone numbers are entered though the keypads and LCD (17 and 15 of FIG. 1, respectively) on the CSD and/or a telephone set with LCD display. The CNID can be either entered ahead of or after the call as long as it stays in the CSD memory buffer.

Various scenarios will be given to better explain the present invention.

Case 1—Always Blocked

The recipient 19 no longer wishes to receive calls from caller 10 under any circumstances and regardless of time of the day. The User stores the caller's telephone number with rules to block all calls originating from that number. The caller places a call to the recipient and the CSD 13 receives the caller's CNID. The CSD searches its database and matches the CNID value with rules stating the call should be blocked under all circumstances (steps 1070-1071 of FIG. 4). The CSD disconnects the call preventing further ringing of the recipient's telephone (step 1198 of FIG. 4).

Case 2—Always Allowed

There are situations that certain calls should never be blocked at all. For example, calls from family members and relatives, etc., regardless of time of the day. The User enters the phone numbers into the database of the CSD with the screening option that they will never be blocked.

A call from the caller 10 to recipient 19 is placed and the telephone company 11 transmits the caller's CNID. The CSD 13 receives the caller's CNID value, checks the database for a matching entry and retrieves all rules associated with that telephone number. The rule specifies that calls from this CNID be always accepted (step 1072), thus it continues to ring the recipient's telephone (step 1199 of FIG. 4).

Case 3—Night time Blocking

The recipient 19 will accept calls from caller 10 during daytime hours but not nighttime hours. The caller's telephone number is stored in the database of the CSD with rules dictating daytime calls from the caller be accepted and nighttime calls be blocked. A call from the caller to the recipient is placed and the telephone company 11 transmits the caller's CNID. The CSD 13 receives the caller's CNID value, checks the database for a matching entry and retrieves all rules associated with that telephone number. The rule associated with the current time dictates how the call will be handled (step 1074 of FIG. 4). If the current time falls within the user-defined daytime range or nighttime screening rules are not used during daytime hours, then the call is accepted and rings the recipient's telephone otherwise be blocked.

Case 4—Nighttime Blocking by group:

The recipient 19 wishes to decline all incoming phone calls in the nighttime except for long distance calls originating from a particular area code, exchange, or a specific telephone number pattern, for example, area code 408. An entry is stored in the database of the CSD for a wildcard CNID value beginning with area code 408. The remaining digits need not required be matched. This CNID is accepted at nighttime hours and under nighttime rules for all other database entries specify the call to be blocked. The user further programs the CSD to only accept calls originating from telephone numbers stored in the database that explicitly state the call is accepted.

A caller 10 from the 408 area code places a nighttime call to the recipient and the telephone company 11 transmits the CNID. The CSD matches the CNID value to the rule governing all area code 408 callers and confirms that the call shall continue ringing the recipient. If the caller had decided to block his telephone number from being transmitted, the telephone company would have sent a CNID specifying that the caller's number be blocked. The CSD retrieves the nighttime rule for callers with blocked CNID and flags the call for blocking. If the authentication option for block flagged calls is on then CSD prompts the caller for a code. The recipient has previously informed the caller of that code. The caller correctly inputs the authentication code, the CSD confirms authentication and allows the call to proceed ringing, otherwise the call be blocked.

Case 5—Day time Blocking

The recipient 19 will not accept calls from caller 10 during daytime hours for personal reasons. For example, the person works night shift. The caller's telephone number is stored in the database of the CSD with rules dictating daytime calls from the caller be blocked. A call from the caller to the recipient is placed and the telephone company 11 transmits the caller's CNID. The CSD 13 receives the caller's CNID value, checks the database for a matching entry and retrieves all rules associated with that telephone number.

The rule associated with the current time rules dictate how the call will be handled (step 1076 of FIG. 4). If the CNID is flagged for blocking during daytime the call is accepted and continue to ring (step 1199). On the other hand, the caller will be prompted and offered “n” times of opportunity to enter a valid pass code in order for the call to get through (step 1190 of FIG. 4) and the call is allowed to continue to ring the recipient phone (step 1199 of FIG. 4). Failure to enter a valid pass code will result the line being disconnected (step 1198 of FIG. 4). If the current time falls within the user-defined nighttime range then the call is accepted and rings the recipient's telephone otherwise be blocked.

Case 6—Forcing Nighttime Blocking During Daytime Hours

This is the opposite of Nighttime Blocking. The recipient 19 does not want calls from caller 10 during day hours for personal reasons. For example, the recipient works night shift. The CSD has the capability to force nighttime screening rules to be used during day hours. It is done through the flip of an external switch, software setting, or an automated process on the CSD or a combination of any of these. This nighttime enforcement can be a temporary or permanent one. A temporary one has effect until the next time zone changes while a permanent one stays on until the User changes it back.

A call from the caller to the recipient is placed and the telephone company 11 transmits the caller's CNID. The CSD 13 receives the caller's CNID value, checks the database for a matching entry and retrieves all rules associated with that telephone number. It uses the nighttime screening rules even though if may be daytime. The rule associated with the current time dictates how the call will be handled (steps 1074 and 1078 of FIG. 4).

Case 7—A Call with Invalid CNID or CNID Error

Quite frequent a caller may not want to have his phone number and name be transmitted to the recipient. He can do so by subscribing the blocking service from his local telephone company or by entering a special command to override it during dialing. It is still possible that the CNID corrupted during transmission by the telephone companies, or such service is unavailable. The recipient 19 will not be able to get a valid CNID to match up the database entries.

A call from the caller to the recipient is placed and the telephone company 11 transmits the caller's CNID. The CSD 13 receives the caller's CNID value and found it is an invalid CNID or CNID Error by step 105 of FIG. 2. The CSD processes an invalid CNID call as in step 106 of FIG. 2. If daytime screening rules are used and that system authentication is off, then the call is not blocked (step 110). On the other hand, it undergoes a series of pass code authentication to determine whether it should be blocked or allowed (steps 111 and 113 of FIG. 2).

The foregoing embodiments and examples serve to describe our invention in a variety of ways; however, other variations of our method are possible falling within the scope of the claims.

1. A method for selective telephone call screening, comprising the steps of:
a) providing a user defined list of calling number identification values (CNIDs) and a list of user screening rules;
b) storing said CNIDs and said screening rules onto a database;
c) receiving a CNID from an incoming telephone call;
d) determining if said CNID of said incoming telephone call is valid or erroneous;
e) selecting a certain set of said screening rules so as to apply to said incoming telephone call, hereafter referred to as the classification of said incoming telephone call;
f) verifying said selected screening rules which have been enabled by a user; and
g) establishing whether said incoming telephone call will be allowed to continue to ring or be terminated pursuant to said selected screening rules.

2. The method of claim 1, wherein said step (e) comprises:
a) retrieving from said database said screening rules for a specific CNID error when a CNID is erroneous;
b) searching said database for a match to a unique received CNID when said CNID is valid pursuant to said selected screening rules; and
c) retrieving from said database said selected screening rules for instances when the valid CNID is not present in said database.

3. The method of claim 2, wherein said selected screening rules may further include selecting a method to communicate to a calling party that a call has been screened and to prompt the calling party for a response, comprising the steps of:
a) seizing a telephone line and then playing a prerecorded message;
b) prompting for a predefined key entry so as to eliminate incoming automated calling parties; and
c) prompting for a stored pass code entry for caller authentication.

4. The method of claim 1 wherein said database can store said CNIDs for entire area codes and exchanges.

5. The method of claim 1, further comprising providing an electronic device for carrying out said selective telephone screening.

6. The electronic device of claim 5, comprising:
a) line interface means for connecting said electronic device to a telephone line;
b) ring detector means for detecting a ring signal of an incoming call from a telephone company central office (CO);
c) means to receive said CNID information;
d) means to store said CNID and said screening rules' database; and
e) controller means for implementing said method so as to determine whether or not an incoming call is allowed to continue to ring.

7. The electronic device of claim 5, further comprising:
a) means for a user to enter and manage entries into said database;
b) means to display device information and database entries; and
c) means for said user to globally enable and disable said screening rules.

8. The electronic device of claim wherein after said ring detector detects a first ring said CNID receiver decodes said incoming call CNID so that said controller can determine which of said screening rules contained in said database apply to said incoming call, and said controller compares said rules to said user enabled rules so as to determine the outcome of said incoming call.

9. The electronic device of claim 5 wherein
a) the call continues to ring if said controller determines that said incoming call is allowable; and
b) line interface means seizes said telephone line so as to terminate said incoming call if necessary.

10. The electronic device of claim 9 wherein step (b) further comprises:
a) means to play prerecorded massages after a line is seized;
b) controller means to prompt and authenticate an appropriate caller response;
c) ringing a telephone if an appropriate response is received; and
d) disconnecting a telephone line if an inappropriate response is received.

11. The electronic device of claim 5 wherein said database comprises a maskable memory array so as to create wildcard entries.

12. The electronic device of claim 5 wherein said display comprises a liquid crystal display.
